(19) United States
(12) Patent Application Publication
(10) Pub. No.: US 2026/0362517 A1
(43) Pub. Date: Nov. 12, 2026

(54) TDLS COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/131,827

(22) PCT Filed: Nov. 23, 2022
(86) PCT No.: PCT/CN2022/133815

§ 371 Date: May 21, 2025

(51) Int. Cl. H04W 76/12; H04W 28/02

(52) U.S. Cl. CPC H04W 76/12; H04W 28/0268; H04W 28/0278

(57) ABSTRACT

The embodiments of the present disclosure relate to the technical field of mobile communications. Provided are a TDLS communication method, an electronic device, and a storage medium. The TDLS communication method is applied to a first station device (STA), and the method comprises: determining a first radio frame, the first radio frame comprising a first identifier, and the first identifier instructing the first STA to transmit a low-latency service and indicating a tunneled direct link setup (TDLS) channel or extended off-channel TDLS channel corresponding to a traffic identifier (TID) of the low-latency service; and sending the first radio frame so as to instruct an access point device to broadcast, according to the first identifier, that the first STA transmits the low-latency service in the TDLS channel or the off-channel TDLS channel.

### CROSS REFERENCE TO RELATED APPLICATIONS

This application is a US National Phase of a PCT Application No. PCT/CN2022/133815 filed on Nov. 23, 2022, the entire contents of which are incorporated herein by reference in their entireties.

### TECHNICAL FIELD

The embodiments of the present disclosure relate to the field of mobile communication technology, in particular to TDLS communication methods, electronic devices, and storage media.

### BACKGROUND

With the rapid development of mobile communication technology, Wireless Fidelity (Wi-Fi) technology has made tremendous progress in transmission speed and throughput. At present, in Wi-Fi technology, topics such as Ultra High Reliability (UHR) is researched, with the vision of improving the reliability of Wireless Local Area Networks (WLAN) connectivity, reducing latencies, increasing manageability, increasing throughput at different Signal to Noise Ratio (SNR) levels, and reducing device level power consumption. Moreover, in UHR, in order to improve the system throughput, a method of communicating simultaneously in the sub 7 GHz (gigahertz) and 45 GHz and/or 60 GHz frequency bands is proposed.

In UHR, Tunneled Direct Link Setup (TDLS) mechanism is of great significance for the transmission of low latency services. Therefore, it is necessary to provide a way to transmit low latency services through TDLS mechanism to support UHR.

### SUMMARY

The embodiments of the present disclosure provide TDLS communication methods, electronic devices, and storage media to provide a way of transmitting low latency services through the TDLS mechanism.

On the one hand, the embodiments of the present disclosure provide a TDLS communication method performed by a first station (STA), including: determining a first radio frame, where the first radio frame includes a first identifier, where the first identifier indicates the first STA to transmit a low latency service and indicates a tunneled direct link setup (TDLS) channel or an off-channel TDLS channel corresponding to a traffic identifier (TID) of the low latency service; and transmitting the first radio frame to instruct the access point to broadcast, based on the first identifier, that the first STA transmits the low latency service in the TDLS channel or the off-channel TDLS channel.

On the other hand, the embodiments of the present disclosure further provide a TDLS communication method performed by an access point (AP), including: receiving a first radio frame, where the first radio frame includes a first identifier, where the first identifier indicates a first station (STA) to transmit a low latency service and indicates a tunneled direct link setup (TDLS) channel or an off-channel TDLS channel corresponding to a traffic identifier (TID) of the low latency service; and broadcasting, based on the first identifier, that the first STA transmits the low latency service in the TDLS channel or the off-channel TDLS channel.

Embodiments of the present disclosure further provide a TDLS communication method performed by a second station (STA), including: receiving a second radio frame broadcast by an access point device, where the second radio frame includes a second identifier and service period (SP) information of a low latency service, where the second identifier indicates that a first station (STA) transmits the low latency service and indicates a TDLS channel or an off-channel TDLS channel for the low latency service; and transmitting a confirmation message frame to the access point.

On the other hand, the embodiments of the present disclosure further provide an electronic device, which is a first station (STA), including: a determining module, configured to determine a first radio frame, where the first radio frame includes a first identifier, where the first identifier indicates the first STA to transmit a low latency service and indicates a tunneled direct link setup (TDLS) channel or an off-channel TDLS channel corresponding to a traffic identifier (TID) of the low latency service; and a transmitting module, configured to transmit the first radio frame to instruct the access point to broadcast, based on the first identifier, that the first STA transmits the low latency service in the TDLS channel or the off-channel TDLS channel.

Embodiments of the present disclosure further provide an electronic device, which is an access point (AP), including: a first receiving module, configured to receive a first radio frame, where the first radio frame includes a first identifier, where the first identifier indicates a first station (STA) to transmit a low latency service and indicates a tunneled direct link setup (TDLS) channel or an off-channel TDLS channel corresponding to a traffic identifier (TID) of the low latency service; and a transmission module, configured to broadcast, based on the first identifier, that the first STA transmits the low latency service in the TDLS channel or the off-channel TDLS channel.

Embodiments of the present disclosure further provide an electronic device, which is a second station (STA), including: a second receiving module, configured to receive a second radio frame broadcast by a access point device, where the second radio frame includes a second identifier and service period (SP) information of a low latency service, where the second identifier indicates that a first station (STA) transmits the low latency service and indicates a TDLS channel or an off-channel TDLS channel for the low latency service; and a confirmation module, configured to transmit a confirmation message frame to the access point.

The embodiments of the present disclosure further provide an electronic device including a memory, a processor, and a computer program stored on the memory and executable on the processor. The processor executes the program, to implement the method described in one or more of the embodiments of the present disclosure.

The embodiments of the present disclosure further provide a non-transitory computer-readable storage medium on which a computer program is stored. The computer program is executed by a processor, to implement the method described in one or more of the embodiments of the present disclosure.

In the embodiments of the present disclosure, the first STA determines the first radio frame and carries a first identifier in the first radio frame, indicating that the first STA transmits the low latency service and indicating the TDLS channel or off-channel TDLS channel corresponding to the traffic identifier (TID) of the low latency service; and transmits the first radio frame, to instruct the AP to broadcast, based on the first identifier, that the first STA transmits the low latency service in the TDLS channel or the off-channel TDLS channel.

The additional aspects and advantages of the embodiments of the present disclosure will be partially presented in the following description, which will become apparent from the following description or learned through practice of the present disclosure.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained according to these drawings without creative effort.

FIG. 1 is a flowchart of a TDLS communication method provided in the embodiments of the present disclosure.

FIG. 2 is a schematic diagram of the first example of the embodiments of the present disclosure.

FIG. 3 is a schematic diagram of the first example of the embodiments of the present disclosure.

FIG. 4 is a flowchart of the TDLS communication method provided in the embodiments of the present disclosure.

FIG. 5 is a flowchart of the TDLS communication method provided in the embodiments of the present disclosure.

FIG. 6 is a schematic structural diagram of an electronic device provided in the embodiments of the present disclosure.

FIG. 7 is a schematic structural diagram of an electronic device provided in the embodiments of the present disclosure.

FIG. 8 is a schematic structural diagram of an electronic device provided in the embodiments of the present disclosure.

FIG. 9 is a schematic structural diagram of an electronic device provided in the embodiments of the present disclosure.

### DETAILED DESCRIPTION

Embodiments will be described in detail here with the examples thereof expressed in the drawings. Where the following description refers to the drawings, elements with the same numerals in different drawings refer to the same or similar elements unless otherwise indicated. Implementations described in the following embodiments do not represent all implementations consistent with the present disclosure. On the contrary, they are examples of an apparatus and a method consistent with some aspects of the present disclosure described in detail in the appended claims.

The term used in the embodiments of the present disclosure is for the purpose of describing particular examples only and is not intended to limit the present disclosure. As used in the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of one or more of the associated listed items. For example, A and/or B can represent three situations of A alone, A and B simultaneously, and B alone. The character “/” generally indicates that the associated objects before and after “/” are in an “or” relationship. The term ‘a plurality of’ refers to two or more, and therefore, in the embodiments of the present disclosure, ‘a plurality of’ can also be understood as ‘at least two’.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein can be interpreted as “at the time of”, “when” or “in response to determining”.

The technical solutions in the embodiments of the present disclosure are clearly described below with reference to the accompanying drawings in the embodiments of the present disclosure. The embodiments described are merely some embodiments of the present disclosure, and not all embodiments. Other embodiments achieved by those skilled in the art according to the embodiments in the present disclosure without paying creative work shall all fall within the scope of protection of the present disclosure.

The embodiments of the present disclosure provide TDLS communication methods, electronic devices, and storage media to provide a way of transmitting low latency services through the TDLS mechanism.

Where the methods and apparatuses are based on the same application concept. Since the problem-solving principles of the methods and apparatuses are similar, the implementation of the apparatuses and the implementation of methods can be referred to each other, which will not be repeated.

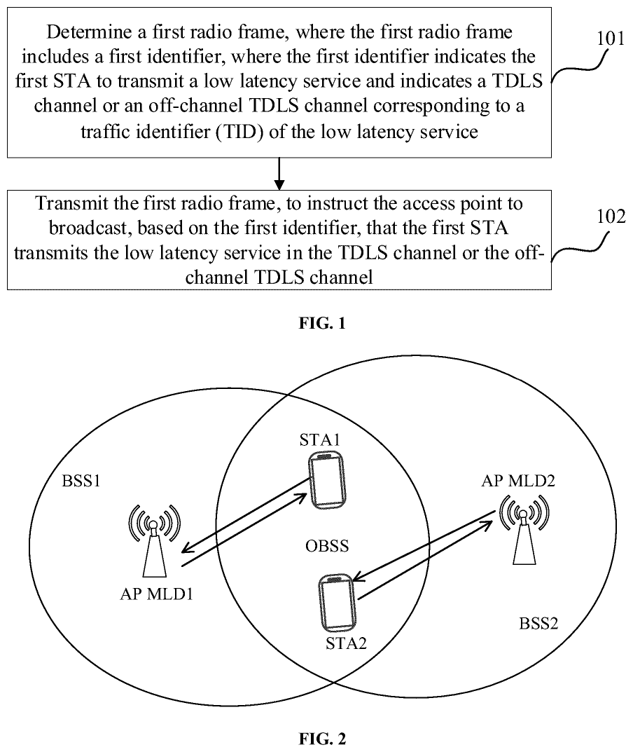

As shown in FIG. 1, the embodiments of the present disclosure provide a TDLS communication method, which can be optionally performed by a first station (STA). In some embodiments of the present disclosure, the access point (AP), such as a device with wireless to wired bridging function, is responsible for extending the services provided by the wired network to the wireless network; the station (STA), such as an electronic device with wireless network access function, provides frame delivery services to facilitate the transmission of information.

The method may include the following step 101 and 102.

In step 101, a first radio frame is determined, where the first radio frame includes a first identifier, where the first identifier indicates the first STA to transmit a low latency service and indicates a TDLS channel or an off-channel TDLS channel corresponding to a traffic identifier (TID) of the low latency service.

In a wireless local area network, a Basic Service Set (BSS) can include an AP and one or more stations (STAs) communicating with the AP. A basic service set can be connected to a Distribution System (DS) through the AP of the basic service set, and then connected to another basic service set to form an Extended Service Set (ESS). As a first example, referring to FIG. 2, AP1 and STA1 form BSS1, and AP2 and STA2 form BSS2. Coverages of two or more BSS overlap to form an Overlapping Basic Service Set (OBSS), as shown in FIG. 2, where BSS1 and BSS2 overlap to form an OBSS.

Optionally, in the embodiments of the present disclosure, AP and STA can be devices that support multiple links. For example, the AP and the STA can be respectively represented as AP MLD and non-AP MLD. AP MLD can represent an access point that supports multi-link communication function, and non-AP MLD can represent a station that supports multi-link communication function.

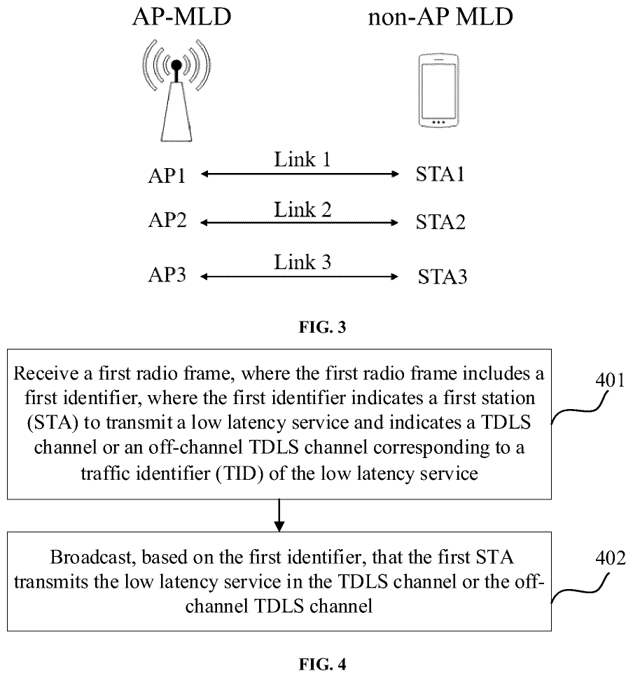

Referring to FIG. 3, AP MLD can include three affiliates APs, AP1, AP2, and AP3 shown in FIG. 3. The APs can operate respectively on Link 1, Link 2, and Link 3. Non-AP MLD can also include three affiliates STAs, STA1, STA2, and STA3 shown in FIG. 2. STA1 works on Link 1, STA2 works on Link 2, and STA3 works on Link 3.

For ease of description, in the following text, an example of communication between one AP and one STA under multi-link connections will be mainly described, which is not limited in the embodiments of the present disclosure. In the example of FIG. 3, assuming that AP1 and STA1 communicate through the corresponding first link (Link 1), similarly, AP2 and STA2 communicate through the corresponding second link (Link 2), and AP3 communicates with STA3 through the third link (Link 3). In addition, Link 1 to Link 3 can be links at different frequencies, such as links at 2.4 GHz, 5 GHz, 6 GHz, or can be several links with the same or different bandwidths at 2.4 GHz. In addition, there can be multiple channels under each link. It can be understood that the communication scenario shown in FIG. 2 is only exemplary, and the concept of the present disclosure is not limited to this. For example, an AP MLD can be connected to multiple (three) non-AP MLDs, or at each link, the AP can communicate with multiple other types of stations.

TDLS technology enables two STAs in the same BSS to bypass the AP and transmit data directly after establishing a TDLS link, thus not being constrained by the AP, and using the fastest rate standard supported by the two STAs for direct transmission. Direct transmission can be carried out on the original channel or switched to a new extended channel, thus avoiding data transmission latency caused by network congestion, which is of great significance for the transmission of the low latency service. In the embodiments of the present disclosure, the first STA is the STA that initiates TDLS channel establishment, and the second STA is the target STA for which the first STA initiates the TDLS. The first STA establishes a TDLS link with the second STA through an AP, and can establish multiple TDLS links with multiple STAs. These TDLS links can be a pair of Non-Simultaneous Transmitting and Receiving (NSTR) links or a pair of Simultaneous Transmitting and Receiving (STR) links.

Specifically, before transmitting low latency service(s), the first STA determines the first radio frame and carries the first identifier in the first radio frame. The first identifier identifies that the first STA will transmit low latency service(s), and on the other hand, identifies a TDLS channel (base channel), a TDLS channel, or an off-channel TDLS channel corresponding to the Traffic Identifier (TID) of the low latency service, to map the TID of the low latency service to the TDLS channel or off-channel TDLS channel. For example, the TDLS channel operates in the 2.4 GHz frequency band, and the off-channel TDLS channel operates in the 5 GHz frequency band.

In returning to FIG. 1, in step 102, the first radio frame is transmitted, to instruct the access point to broadcast, based on the first identifier, that the first STA transmits the low latency service in the TDLS channel or the off-channel TDLS channel.

The first STA transmits the first radio frame, to enable the AP to broadcast, based on the first identifier, that the first STA will transmit the low latency service in the TDLS channel or the off-channel TDLS channel. For example, taking the establishment of a restricted Target Wake Time (rTWT) mechanism as an example, the AP determines the rTWT information element corresponding to the TID based on the TID, and then broadcasts, in the rTWT information element, that the first STA performs TDLS communication for transmitting low latency service(s). Upon receiving the rTWT information element broadcast by the AP, the STA confirms whether the Service Period (SP) of the rTWT is allocated to itself based on the broadcast TWT ID and the address of the AP.

The embodiments of the present disclosure provide a communication method, which can be optionally performed by a first station (STA). The method may include the following steps: determining a first radio frame, where the first radio frame includes a first identifier, where the first identifier indicates the first STA to transmit a low latency service and indicates a TDLS channel or an off-channel TDLS channel corresponding to a traffic identifier (TID) of the low latency service; where the first identifier is included in the Buffer Status Report (BSR) of the first radio frame, and the first STA notifies the AP through BSR that the first STA will transmit low latency service; and transmitting the first radio frame to instruct the access point to broadcast, based on the first identifier, that the first STA transmits the low latency service in the TDLS channel or the off-channel TDLS channel.

The embodiments of the present disclosure provide a communication method, which can be optionally performed by a first station (STA). The method may include the following steps: determining a first radio frame, where the first radio frame includes a first identifier, where the first identifier indicates the first STA to transmit a low latency service and indicates a tunneled direct link setup (TDLS) channel or an off-channel TDLS channel corresponding to a traffic identifier (TID) of the low latency service; where the first identifier is included in the Buffer Status Report (BSR) of the first radio frame, and the first STA notifies the AP through BSR that the first STA will transmit low latency service; transmitting the first radio frame to instruct the access point to broadcast, based on the first identifier, that the first STA transmits the low latency service in the TDLS channel or the off-channel TDLS channel; receiving a second radio frame broadcast by the access point, where the second radio frame includes a second identifier and service period (SP) information, where the second identifier indicates that the first STA transmits the low latency service and indicates the TDLS channel or the off-channel TDLS channel for the low latency service; and obtaining the SP information and transmitting the low latency service in the TDLS channel or the off-channel TDLS channel within the SP corresponding to the SP information.

The first STA transmits a first radio frame to enable the AP to broadcast a second radio frame, where the second radio frame includes a second identifier and service period (SP) information. The second identifier indicates that the first STA transmits low latency service and indicates the TDLS channel or the off-channel TDLS channel for the low latency service. For example, taking the establishment of the rTWT mechanism as an example, the AP determines, according to the TID, the rTWT information element corresponding to the TID, and then carries the rTWT information element in the second radio frame, and broadcasts the second radio frame, broadcasting that the first STA performs TDLS communication for transmitting the low latency service through the second identifier.

Upon receiving the rTWT information element broadcast by the AP, the STA confirms whether the service period (SP) of the rTWT is allocated to itself based on the broadcast TWT ID and the address of the AP. In the SP allocated to the STA, the STA transmits the low latency service to the second STA in the TDLS channel or the off-channel TDLS channel.

In an optional embodiment, the duration of the SP is determined based on the size of the BSR. The first STA transmits the amount of data to be transmitted in the low latency service to the AP through BSR, and the AP determines the amount of data based on BSR, and then allocates a service period for the low latency service based on the amount of data to be transmitted.

The embodiments of the present disclosure provide a communication method, which can be optionally performed by a first station (STA). The method may include the following steps: determining TDLS channel(s) or off-channel TDLS channel(s) corresponding to TID(s) of one or more low latency services; where before transmitting a low latency service, the first STA first maps the TID of the low latency service to the corresponding TDLS channel or the off-channel TDLS channel; determining a first radio frame, where the first radio frame includes a first identifier, where the first identifier indicates the first STA to transmit a low latency service and indicates a TDLS channel or an off-channel TDLS channel corresponding to a traffic identifier (TID) of the low latency service; and transmitting the first radio frame to instruct the access point to broadcast, based on the first identifier, that the first STA transmits the low latency service in the TDLS channel or the off-channel TDLS channel.

In the embodiments of the present disclosure, the first STA determines the first radio frame and carries a first identifier in the first radio frame, indicating that the first STA transmits the low latency service and indicating the TDLS channel or off-channel TDLS channel corresponding to the traffic identifier (TID) of the low latency service; and transmits the first radio frame, to instruct the AP to broadcast, based on the first identifier, that the first STA transmits the low latency service in the TDLS channel or the off-channel TDLS channel. The embodiments of the present disclosure provide a way to transmit the low latency service through TDLS mechanism, making it suitable for UHR requirements.

Referring to FIG. 4, the embodiments of the present disclosure provide a TDLS communication method. Optionally, the method can be performed by a network device, which may be an access point (AP). The method may include the following steps 401 and 402.

In step 401, a first radio frame is received, where the first radio frame includes a first identifier, where the first identifier indicates a first station (STA) to transmit a low latency service and indicates a TDLS channel or an off-channel TDLS channel corresponding to a traffic identifier (TID) of the low latency service.

TDLS technology enables two STAs in the same BSS to bypass the AP and transmit data directly after establishing a TDLS link, thus not being constrained by the AP, and using the fastest rate standard supported by the two STAs for direct transmission. Direct transmission can be carried out on the original channel or switched to a new extended channel, thus avoiding data transmission latency caused by network congestion, which is of great significance for the transmission of the low latency service. In the embodiments of the present disclosure, the first STA is the STA that initiates TDLS channel establishment, and the second STA is the target STA for which the first STA initiates the TDLS. The first STA establishes a TDLS link with the second STA through an AP, and can establish multiple TDLS links with multiple STAs. These TDLS links can be a pair of Non-Simultaneous Transmitting and Receiving (NSTR) links or a pair of Simultaneous Transmitting and Receiving (STR) links.

Specifically, before transmitting low latency service(s), the AP receives the first radio frame transmitted by the first STA and obtains the first identifier carried in the first radio frame. The first identifier identifies that the first STA will transmit low latency service(s), and on the other hand, identifies the TDLS channel (base channel), TDLS channel, or off-channel TDLS channel corresponding to the Traffic Identifier (TID) of the low latency service, to map the TID of the low latency service to the TDLS channel or off-channel TDLS channel. For example, the TDLS channel operates in the 2.4 GHz frequency band, and the off-channel TDLS channel operates in the 5 GHz frequency band.

In step 402, that the first STA transmits the low latency service in the TDLS channel or the off-channel TDLS channel is broadcast based on the first identifier.

The AP broadcasts, based on the first identifier, that the first STA will transmit the low latency service in the TDLS channel or the off-channel TDLS channel. For example, taking the establishment of the rTWT mechanism as an example, the AP determines the rTWT information element corresponding to the TID based on the TID, and then broadcasts, in the rTWT information element, that the first STA performs TDLS communication for transmitting the low latency service. Upon receiving the rTWT information element broadcast by the AP, the STA (first STA and second STA) confirms, based on the broadcast TWT ID and the address of the AP, whether the service period (SP) of the rTWT is allocated to itself. In the SP allocated to the STA, the first STA transmits the low latency service to the second STA in the TDLS channel or the off-channel TDLS channel.

The embodiments of the present disclosure provide a TDLS communication method. Optionally, the method can be performed by a network device, which may be an access point (AP). The method may include the following steps: receiving a first radio frame, where the first radio frame includes a first identifier, where the first identifier indicates the first STA to transmit a low latency service and indicates a TDLS channel or an off-channel TDLS channel corresponding to a traffic identifier (TID) of the low latency service; where the first identifier is included in the Buffer Status Report (BSR) of the first radio frame, and the first STA notifies the AP through BSR that the first STA will transmit low latency service; and broadcasting, based on the first identifier, that the first STA transmits the low latency service in the TDLS channel or the off-channel TDLS channel.

The embodiments of the present disclosure provide a TDLS communication method. Optionally, the method can be performed by a network device, which may be an access point (AP). The method may include the following steps: receiving a first radio frame, where the first radio frame includes a first identifier, where the first identifier indicates the first STA to transmit a low latency service and indicates a TDLS channel or an off-channel TDLS channel corresponding to a traffic identifier (TID) of the low latency service; where the first identifier is included in the Buffer Status Report (BSR) of the first radio frame; and broadcasting, based on the first identifier, that the first STA transmits the low latency service in the TDLS channel or the off-channel TDLS channel. Broadcasting, based on the first identifier, that the first STA transmits the low latency service in the TDLS channel or the off-channel TDLS channel includes: determining a second radio frame, where the second radio frame includes a second identifier and service period (SP) information of the low latency service, where the second identifier indicates that the first STA transmits the low latency service and indicates the TDLS channel or the off-channel TDLS channel for the low latency service; and broadcasting the second radio frame.

The AP broadcasts a second radio frame, where the second radio frame includes a second identifier and service period (SP) information. The second identifier indicates that the first STA transmits low latency service and indicates the TDLS channel or the off-channel TDLS channel for the low latency service. For example, taking the establishment of the rTWT mechanism as an example, the AP determines, according to the TID, the rTWT information element corresponding to the TID, and then carries the rTWT information element in the second radio frame, and broadcasts the second radio frame, broadcasting that the first STA performs TDLS communication for transmitting the low latency service through the second identifier.

Upon receiving the rTWT information element broadcast by the AP, the STA (first STA and second STA) confirms, based on the broadcast TWT ID and the address of the AP, whether the service period (SP) of the rTWT is allocated to itself. In the SP allocated to the STA, the first STA transmits the low latency service to the second STA in the TDLS channel or the off-channel TDLS channel.

In an optional embodiment, the duration of the SP is determined based on the size of the BSR. The first STA transmits the amount of data to be transmitted in the low latency service to the AP through BSR, and the AP determines the amount of data based on BSR, and then allocates a service period for the low latency service based on the amount of data to be transmitted.

In the embodiments of the present disclosure, the AP receives the first radio frame, obtains the first identifier carried in the first radio frame, and broadcasts, based on the first identifier, that the first STA transmits the low latency service in the TDLS channel or the off-channel TDLS channel. The embodiments of the present disclosure provide a way to transmit the low latency service through TDLS mechanism, making it suitable for UHR requirements.

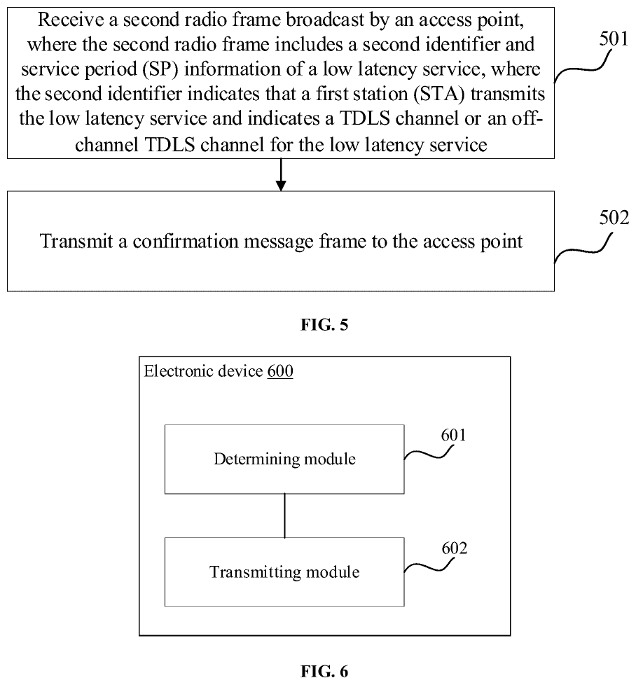

Referring to FIG. 5, the embodiments of the present disclosure provide a communication method, which can be optionally performed by the second STA. The method may include the following steps 501 and 502.

In step 501, a second radio frame broadcast by an access point is received, where the second radio frame includes a second identifier and service period (SP) information of a low latency service, where the second identifier indicates that a first station (STA) transmits the low latency service and indicates a TDLS channel or an off-channel TDLS channel for the low latency service.

Before transmitting the low latency service, the AP broadcasts through the second radio frame that the first STA will transmit the low latency service in the TDLS channel or the off-channel TDLS channel. The second STA receives the second radio frame, determines that the low latency service will be transmitted on the TDLS channel or off-channel TDLS channel based on the second identifier in the second radio frame, and determines the time to receive the low latency service through the SP information of the low latency service.

In step 502, a confirmation message frame is transmitted to the access point.

The second STA transmits a confirmation message frame to the AP, to enable the AP and the first STA to confirm that the low latency service can be transmitted to the second STA on the TDLS channel or off-channel TDLS channel. The embodiments of the present disclosure provide a way to transmit the low latency service through TDLS mechanism, making it suitable for UHR requirements.

Referring to FIG. 6, based on the same principle as the methods provided in the embodiments of the present disclosure, the embodiments of the present disclosure further provide an electronic device 600, which is a first station (STA), including a determining module 601 and a transmitting module 602.

The determining module 601 is configured to determine a first radio frame, where the first radio frame includes a first identifier, where the first identifier indicates the first STA to transmit a low latency service and indicates a TDLS channel or an off-channel TDLS channel corresponding to a traffic identifier (TID) of the low latency service.

The transmitting module 602 is configured to transmit the first radio frame to instruct the access point to broadcast, based on the first identifier, that the first STA transmits the low latency service in the TDLS channel or the off-channel TDLS channel.

In an optional embodiment, the first identifier is included in a buffer status report (BSR) of the first radio frame.

In an optional embodiment, the electronic device further includes: a third receiving module (not shown), configured to receive a second radio frame broadcast by the access point, where the second radio frame includes a second identifier and service period (SP) information, where the second identifier indicates that the first STA transmits the low latency service and indicates the TDLS channel or the off-channel TDLS channel for the low latency service; and an obtaining module (not shown), configured to obtain the SP information and transmitting the low latency service in the TDLS channel or the off-channel TDLS channel within the SP corresponding to the SP information.

In an optional embodiment, the duration of the SP is determined based on the size of the BSR.

In an optional embodiment, the electronic device further includes: a channel determining module (not shown), configured to determine TDLS channel(s) or off-channel TDLS channel(s) corresponding to TID(s) of one or more low latency services.

The embodiments of the present disclosure further provide a TDLS communication apparatus applied to a first station (STA), including: a radio frame determining module, configured to determine a first radio frame, where the first radio frame includes a first identifier, where the first identifier indicates the first STA to transmit a low latency service and indicates a TDLS channel or an off-channel TDLS channel corresponding to a traffic identifier (TID) of the low latency service; and a radio frame transmitting module, configured to transmit the first radio frame to instruct the access point to broadcast, based on the first identifier, that the first STA transmits the low latency service in the TDLS channel or the off-channel TDLS channel.

The apparatus further includes other modules of the electronic device in the previous embodiments, which will not be repeated here.

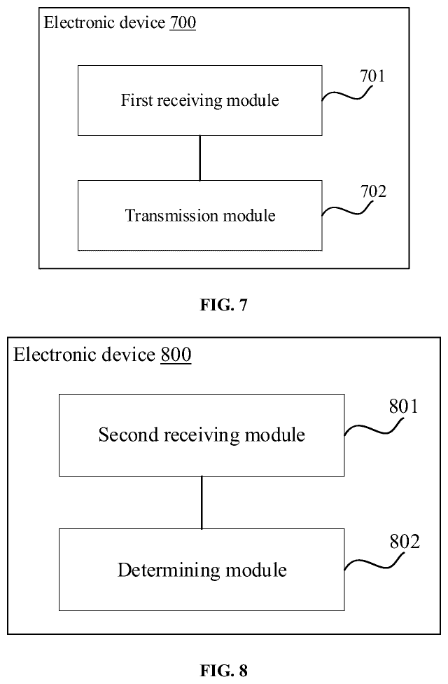

Referring to FIG. 7, based on the same principle as the methods provided in the embodiments of the present disclosure, the embodiments of the present disclosure further provide an electronic device 700, which is a first station (STA), including a first receiving module 701 and a transmission module 702.

The first receiving module 701 is configured to receive a first radio frame, where the first radio frame includes a first identifier, where the first identifier indicates a first station (STA) to transmit a low latency service and indicates a TDLS channel or an off-channel TDLS channel corresponding to a traffic identifier (TID) of the low latency service.

The transmission module 702 is configured to broadcast, based on the first identifier, that the first STA transmits the low latency service in the TDLS channel or the off-channel TDLS channel.

In an optional embodiment, the first identifier is included in a buffer status report (BSR) of the first radio frame.

In an optional embodiment, the transmission module 702 is configured to: determine a second radio frame, where the second radio frame includes a second identifier and service period (SP) information of the low latency service, where the second identifier indicates that the first STA transmits the low latency service and indicates the TDLS channel or the off-channel TDLS channel for the low latency service; and broadcast the second radio frame.

In an optional embodiment, the duration of the SP is determined based on the size of the BSR.

The embodiments of the present disclosure further provide a TDLS communication apparatus applied to a first station (STA), including: a first receiving module (not shown), configured to receive a first radio frame, where the first radio frame includes a first identifier, where the first identifier indicates a first station (STA) to transmit a low latency service and indicates a TDLS channel or an off-channel TDLS channel corresponding to a traffic identifier (TID) of the low latency service; and a transmission module (not shown), configured to broadcast, based on the first identifier, that the first STA transmits the low latency service in the TDLS channel or the off-channel TDLS channel.

The apparatus further includes other modules of the electronic device in the previous embodiments, which will not be repeated here.

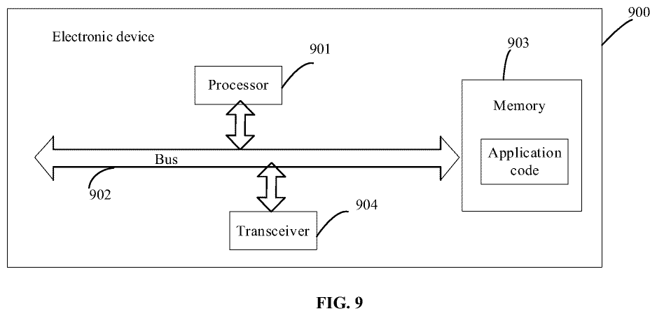

Referring to FIG. 8, based on the same principle as the methods provided in the embodiments of the present disclosure, the embodiments of the present disclosure further provide an electronic device 800, which is a first station (STA), including a second receiving module 801 and a confirmation module 802.

The second receiving module 801 is configured to receive a second radio frame broadcast by an access point device, where the second radio frame includes a second identifier and service period (SP) information of a low latency service, where the second identifier indicates that a first station (STA) transmits the low latency service and indicates a TDLS channel or an off-channel TDLS channel for the low latency service.

The confirmation module 802 is configured to transmit a confirmation message frame to the access point.

The embodiments of the present disclosure further provide a TDLS communication apparatus applied to a first station (STA), including: a second receiving module, configured to receive a second radio frame broadcast by a access point device, where the second radio frame includes a second identifier and service period (SP) information of a low latency service, where the second identifier indicates that a first station (STA) transmits the low latency service and indicates a TDLS channel or an off-channel TDLS channel for the low latency service; and a confirmation module, configured to transmit a confirmation message frame to the access point.

The apparatus further includes other modules of the electronic device in the previous embodiments, which will not be repeated here.

In an optional embodiment, the present disclosure further provides an electronic device, as shown in FIG. 9. The electronic device 900 shown in FIG. 9 can be a server, including a processor 901 and a memory 903. Where the processor 901 is connected to the memory 903, such as through a bus 902. Optionally, the electronic device 900 may also include a transceiver 904. It should be noted that in practical applications, the transceiver 904 is not limited to one, and the structure of the electronic device 900 does not constitute a limitation on the embodiments of the present disclosure.

The processor 901 can be a CPU (Central Processing Unit), general-purpose processor, DSP (Digital Signal Processor), ASIC (Application Specific Integrated Circuit), FPGA (Field Programmable Gate Array), or any combination thereof. It can implement or execute various exemplary logical blocks, modules, and circuits described in conjunction with the present disclosure. The processor 901 can also be a combination that implements computing functions, such as a combination containing one or more microprocessors, a combination of DSP and microprocessors, etc.

Bus 902 may include a pathway for transmitting information between the aforementioned components. Bus 902 can be a PCI (Peripheral Component Interconnect) bus or an EISA (Extended Industry Standard Architecture) bus, etc. Bus 902 can be divided into address bus, data bus, control bus, etc. For ease of representation, only one thick line is used in FIG. 9, but it does not indicate that there is only one bus or one type of bus.

The memory 903 can be a ROM (Read Only Memory) or other types of static storage devices that can store static information and instructions, or RAM (Random Access Memory) or other types of dynamic storage devices that can store information and instructions, can also be EEPROM (Electrically Erasable Programmable Read Only Memory), CD-ROM (Compact Disc Read Only Memory) or other optical disc storage, optical disc storage (including compressed optical discs, laser discs, optical discs, digital versatile discs, Blu ray discs, etc.), magnetic disk storage media or other magnetic storage devices, or any other medium that can be used to carry or store desired program code in the form of instructions or data structures and can be accessed by a computer, which is not limited.

The memory 903 is used to store the application program code for executing the disclosed scheme, and is controlled for execution by the processor 901. The processor 901 is used to execute the application program code stored in the memory 903 to implement the content shown in the aforementioned method embodiments.

Where electronic devices include but are not limited to mobile terminals such as mobile phones, laptops, digital broadcast receivers, PDAs (personal digital assistants), PADs (tablets), PMPs (portable multimedia players), car terminals (such as car navigation terminals), and fixed terminals such as digital TVs, desktop computers, and so on. The electronic device shown in FIG. 9 is only an example and should not impose any limitations on the scope of function and use of the embodiments of the present disclosure.

The servers provided in the present disclosure can be independent physical servers, server clusters or distributed systems composed of multiple physical servers, or cloud services, cloud databases, cloud computing, cloud functions, cloud storage, network services, cloud communication, middleware services, domain name services, security services, CDNs, or cloud servers for basic cloud computing services such as big data and artificial intelligence platforms. The terminal can be a smartphone, tablet, laptop, desktop computer, smart speaker, smartwatch, etc., which is not limited. Terminals and servers can be directly or indirectly connected through wired or wireless communication methods, which is not limited in the present disclosure.

The embodiments of the present disclosure provide a non-transitory computer-readable storage medium on which a computer program is stored, which, when run on a computer, enables the computer to execute the corresponding content of the aforementioned method embodiments.

It should be understood that although the various steps in the flowchart of figures are displayed in sequence according to the arrows, these steps are not necessarily executed in sequence in the order indicated by the arrows. Unless otherwise specified in this article, there is no strict order limit for the execution of these steps, and they can be executed in other orders. Moreover, at least some of the steps in the flowchart of the attached figures. may include multiple sub-steps or stages, which are not necessarily completed at the same time, but can be executed at different times. Their execution order is not necessarily sequential, but can be rotated or alternated with at least some of other steps or the sub-steps or stages of other steps.

It should be noted that the non-transitory computer-readable medium mentioned in the present disclosure can be a computer-readable signal medium, a computer-readable storage medium, or any combination of the two. Computer readable storage media can be, for example but not limited to, systems, devices, or elements of electricity, magnetism, light, electromagnetism, infrared, or semiconductors, or any combination thereof. More specific examples of non-transitory computer-readable storage media may include, but are not limited to, electrical links with one or more wires, portable computer disks, hard drives, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof. In the present disclosure, a computer-readable storage medium can be any tangible medium containing or storing a program that can be used by an instruction execution system, apparatus, or device, or used in combination with it. In the present disclosure, computer-readable signal media may include data signals propagated in the baseband or as part of a carrier wave, carrying computer-readable program code. This propagated data signal can take various forms, including but not limited to electromagnetic signals, optical signals, or any suitable combination thereof. Computer readable signal media can also be any computer-readable medium other than computer-readable storage media, which can transmit, propagate, or transmit programs for use by or in combination with instruction execution systems, devices, or equipment. The program code contained on a computer-readable medium can be transmitted using any suitable medium, including but not limited to: wires, optical cables, RF (radio frequency), etc., or any suitable combination of the above.

The non-transitory computer-readable medium mentioned may be included in the electronic device mentioned herein, and can also exist independently without being assembled into the electronic device.

The non-transitory computer-readable medium carries one or more programs, which, when executed by the electronic device, cause the electronic device to perform the method shown in the above embodiments.

According to one aspect of the present disclosure, there is provided a computer program product or computer program including computer instructions stored in a non-transitory computer-readable storage medium. The processor of a computer device reads the computer instructions from a non-transitory computer-readable storage medium, executes the computer instructions, and causes the computer device to perform the methods provided in the various optional implementations mentioned above.

Computer program code for performing the operations in the present disclosure can be written in one or more programming languages or combinations thereof, including object-oriented programming languages such as Java, Smalltalk, C++, or conventional procedural programming languages such as “C” language or similar programming languages. The program code can be completely executed on the user's computer, partially executed on the user's computer, executed as an independent software package, partially executed on the user's computer and partially executed on a remote computer, or completely executed on a remote computer or server. In cases involving remote computers, remote computers can connect to user computers through any type of network, including local area networks (LANs) or wide area networks (WANs), or can connect to external computers (such as using internet service providers to connect via the internet).

The flowchart and block diagram in the attached figures illustrate the possible implementation architecture, functions, and operations of the system, method, and computer program product according to various embodiments of the present disclosure. In this regard, each box in a flowchart or block diagram can represent a portion of a module, program segment, or instruction that contains one or more executable instructions for implementing a specified logical function. It should also be noted that in some alternative implementations, the functions indicated in the box can also occur in a different order than those indicated in the accompanying drawings. For example, two consecutive boxes can actually be executed in basic parallel, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or actions, or can be implemented using a combination of dedicated hardware and computer instructions.

The modules described in the embodiments of the present disclosure can be implemented through software or hardware. Where the name of the module does not constitute a limitation on the module itself in some cases. For example, Module A can also be described as “Module A configured to perform B operations”.

The above description is only a preferred embodiment of the present disclosure and an explanation of the technical principles applied. Those skilled in the art should understand that the scope of the present disclosure referred to in the present disclosure is not limited to technical solutions formed by specific combinations of the above technical features, and should also cover other technical solutions formed by arbitrary combinations of the above technical features or their equivalent features without departing from the above disclosed concept. For example, a technical solution formed by replacing the above features with (but not limited to) technical features with similar functions disclosed in the present disclosure.

1. A tunneled direct link setup (TDLS) communication method, performed by a first station (STA), comprising:
determining a first radio frame, wherein the first radio frame comprises a first identifier, wherein the first identifier indicates the first STA to transmit a low latency service and indicates a TDLS channel or an off-channel TDLS channel corresponding to a traffic identifier (TID) of the low latency service; and
transmitting the first radio frame to instruct an access point (AP) to broadcast, based on the first identifier, that the first STA transmits the low latency service in the TDLS channel or the off-channel TDLS channel.

2. The TDLS communication method according to claim 1, wherein the first identifier is comprised in a buffer status report (BSR) of the first radio frame.

3. The TDLS communication method according to claim 2, wherein after transmitting the first radio frame, the method further comprises:
receiving a second radio frame broadcast by the AP, wherein the second radio frame comprises a second identifier and service period (SP) information, wherein the second identifier indicates that the first STA transmits the low latency service and indicates the TDLS channel or the off-channel TDLS channel for the low latency service; and
obtaining the SP information and transmitting the low latency service in the TDLS channel or the off-channel TDLS channel within the SP corresponding to the SP information.

4. The TDLS communication method according to claim 3, wherein duration of the SP is determined based on a size of the BSR.

5. The TDLS communication method according to claim 1, wherein before determining the first radio frame, the method further comprises:
determining the TDLS channel or the off-channel TDLS channel corresponding to the TID of one or more low latency services comprising the low latency service.

6. A tunneled direct link setup (TDLS) communication method, performed by an access point (AP), comprising:
receiving a first radio frame, wherein the first radio frame comprises a first identifier, wherein the first identifier indicates a first station (STA) to transmit a low latency service and indicates a TDLS channel or an off-channel TDLS channel corresponding to a traffic identifier (TID) of the low latency service; and
broadcasting, based on the first identifier, that the first STA transmits the low latency service in the TDLS channel or the off-channel TDLS channel.

7. The TDLS communication method according to claim 6, wherein the first identifier is comprised in a buffer status report (BSR) of the first radio frame.

8. The TDLS communication method according to claim 7, wherein broadcasting, based on the first identifier, that the first STA transmits the low latency service in the TDLS channel or the off-channel TDLS channel comprises:
determining a second radio frame, wherein the second radio frame comprises a second identifier and service period (SP) information of the low latency service, wherein the second identifier indicates that the first STA transmits the low latency service and indicates the TDLS channel or the off-channel TDLS channel for the low latency service; and
broadcasting the second radio frame.

9. The TDLS communication method according to claim 8, wherein duration of the SP is determined based on a size of the BSR.

10. A tunneled direct link setup (TDLS) communication method, performed by a second station (STA), comprising:
receiving a second radio frame broadcast by an AP, wherein the second radio frame comprises a second identifier and service period (SP) information of a low latency service, wherein the second identifier indicates that a first (STA) transmits the low latency service and indicates a TDLS channel or an off-channel TDLS channel for the low latency service; and
transmitting a confirmation message frame to the AP.

11-13. (canceled)

14. An electronic device comprising:
one or more memories;
one or more processors; and
a computer program stored on the one or more memories and runnable on the one or more processors, and
wherein the one or more processors execute the computer program to implement the TDLS communication method according to claim 1.

15. A non-transitory computer readable storage medium, wherein the non-transitory computer readable storage medium stores a computer program, and when one or more processors execute the computer program, the computer program causes the one or more processors to implement the TDLS communication method according to claim 1.

16. An electronic device comprising:
one or more memories;
one or more processors; and
a computer program stored on the one or more memories and runnable on the one or more processors, and
wherein the one or more processors execute the computer program to implement the TDLS communication method according to claim 6.

17. A non-transitory computer readable storage medium, wherein the non-transitory computer readable storage medium stores a computer program, when one or more processors execute the computer program, the computer program causes the one or more processors to implement the TDLS communication method according to claim 6.

18. An electronic device comprising:
one or more memories;
one or more processors; and
a computer program stored on the one or more memories and runnable on the one or more processors, and
wherein the one or more processors execute the computer program to implement the TDLS communication method according to claim 10.

19. A non-transitory computer readable storage medium, wherein the non-transitory computer readable storage medium stores a computer program, and when one or more processors execute the computer program, the computer program causes the one or more processors to implement the TDLS communication method according to claim 10.
